(19) United States
(12) Patent Application Publication
(10) Pub. No.: US 2006/0072522 A1
(43) Pub. Date: Apr. 6, 2006

(54) Call parameter selection and self-enforced admission control for optimizing voice over internet protocol performance in wireless networks

(76) Inventors: Praphul Chandra, Germantown, MD (US); David Lide, Rockville, MD (US); Satish Kumar M. Mundra, Germantown, MD (US); Manoj Sindhwani, Oak Hill, VA (US)

Correspondence Address: TEXAS INSTRUMENTS INCORPORATED, P O BOX 655474, M/S 3999, DALLAS, TX, 75265, US

(21) Appl. No.: 10/953,683

(22) Filed: Sep. 29, 2004

(51) Int. Cl. H04Q 7/24

(52) U.S. Cl. 370/338

(57) ABSTRACT

A method for transmitting voice data traffic over a wireless medium using a decision process for the admission of a voice call, such as a call voice over Internet Protocol (VoIP) over a wireless local area network (WLAN). Admission of the call through the network is based upon the priority level of the call and a congestion level of the WLAN in order to increase the quality and the number of calls on a BSS. Paramters such as codec and packetization periods are selected for the call based upon the priority and congestion level. As the level of congestion in the network Increases, only calls above a certain Priority level are allowed into the network.

### CROSS-REFERENCE TO RELATED APPLICATIONS

None

### FIELD OF THE INVENTION

The present invention relates generally to transmitting voice data over a wireless local area network (WLAN), and more specifically for selecting call parameters and allowing the admission of a voice over Internet Protocol (VoIP) over WLAN call, based upon the priority level of the call and congestion level of the network.

### BACKGROUND OF THE INVENTION

WLANs (Wireless Local Area Networks) utilize RF (Radio Frequency) signals or light signals to connect mobile endpoints to each other or to a centralized gateway and transmit data over a wireless medium between the physical endpoints or between a mobile endpoint and an endpoint on a network that is connected to the WLAN. In 1997 the IEEE published standards for WLANs under the title of 802.11 (also known as “Wi-Fi”). The IEEE 802.11b protocol has gained popularity over the past few years and deployment of 802.11b networks is expected to increase significantly in the near future. Currently, most of these networks are used for data access from laptop computers and personal digital assistants (PDAs). Using a WLAN to place voice phone calls using VoIP (Voice over Internet Protocols) over WLAN is also expected to grow significantly in the near future. However, VoIP over WLAN presents a unique set of problems that must be addressed prior implementing this technology.

One of the most important problems in this area is the provision of adequate system capacity to support some significant number of VoIP connections per BSS (Basic Service Set). The basic hardware setup of an IEEE 802.11 network is the Basic Service Set (BSS), which is merely a number of endpoint stations that communicate with one another. IEEE 802.11 protocols enable mobile stations (e.g., endpoints) to communicate through a wireless network interface directly with each other or with other stations (STAs) through an access point. An access point (AP) is a centralized gateway providing message and power management and access to an external LAN (Local Area Network) and/or the Internet.

There exists a plurality of 802.11 standards that each use different frequency bands and have varying data transmission speeds. The original IEEE 802.11b standard supported wireless interfaces operating at speeds of up to 2 megabyte per second (Mbps) in the 2.4 GHz radio band. By using different modulation techniques, IEEE 802.11b raised the data transmission rates to 11 Mbps, while 802.11a supports up to 54 Mbps transmission rates at a 5 GHz frequency. The IEEE 802.11g is developing standards for data transmission rates of 54 Mbps at the 2.4 GHz frequency.

WLANs under 802.11 use media access control (MAC) protocols to transmit between wired and wireless devices. Each wireless network card is assigned a MAC address used to identify the station. The access to wireless networks is controlled by coordination functions. The distributed coordination function (DCF) provides access similar to Ethernet CSMA/CA access. The DCF determines if the RF link between devices is clear prior to transmitting. Stations use a random backoff after every frame to avoid collisions. Endpoint stations provide MAC Service Data Units (MSDUs) after detecting no current transmissions. The MSDUs functions to transmit data frames to the proper endpoint station.

Under the DCF access method of 802.11, each MSDU transmission incurs an overhead that includes a distributed interface space (DIFS) duration, a backoff interval, a Physical Layer Convergence Procedure (PLCP) preamble, a PLCP header, a MAC header, a SIFS duration, and an acknowledgment (ACK) time (which comprises a PLCP preamble, a PLCP header, and the ACK MPDU). Such an overhead amounts up to 764.2 μs on an 802.11 b PHY with long PLCP preamble an 11 Mbps data rate, which can significantly decrease quality of data transmission. Thus, the more frames transmitted, the higher the overhead traffic in the network.

FIG. 1 illustrates a schematic diagram of an exemplary WLAN enterprise network under IEEE 802.11 protocols. One basic service set (BSS) has a wireless access point (AP) 12 and a second BSS has its own AP 14. An AP bridges data with wireless STAs that are associated with that AP. An enterprise network typically has multiple BSSs and multiple APs distributed throughout an office complex or among floors on buildings so that a wireless STA may be operated from nearly anywhere in a complex or building. Each AP in a BSS has an RF signal propagation broadcast area that has an effective range based upon broadcast power, natural signal attenuation, and interferences. AP1 12 has an RF propagation area defined exemplarily by coverage ring 13, and AP2 14 has an RF propagation area defined exemplarily by coverage ring 15. Both APs 12,14 are connected to an internal corporate intranet 20. The Internet 26 may be accessed through intranet 20 and gateway 22 or alternatively through AP1 12 through a Radius authentication server 24.

The 802.11b MAC (Media Access Controller) is designed keeping in mind data traffic over the wireless medium. Since collisions are hard to detect, each packet is acknowledged (ACKed) by the receiver. Since the medium is shared, access to the medium is based on detecting the network idle (physically or logically) and on random back-off times. Since downstream traffic (from the AP to the laptops/PDAs) is usually much higher than the upstream traffic, 802.11b is inherently fair allowing each node equal access to the medium.

However, the above design decisions do not work well for VoIP over WLAN. First, the per-frame transmission overhead for 802.11b is very high. Besides the RTP (Real Time Protocol), UDP (User Data Protocol) and IP (Internet Protocol) headers, which are inherent overheads in VoIP traffic, working with WLAN adds the high physical layer overhead which always gets transmitted at 1 Mbps. Besides the physical layer overhead, each data frame is also ACKed by the receiver. This adds another large overhead, increasing the size of each packet transmitted. Finally, the 802.11MAC scheme of waiting for fixed (irrespective of payload size) collision avoidance sense timeouts (DIFS, SIFS) and random back-off times leads to another overhead increase in packet/frame size.

Given these overheads, it is not surprising that even though the maximum data rate that 802.11b currently supports is 11 Mbps, the theoretically maximum achievable throughput for 802.11b networks is much less. FIG. 2 illustrates a graph showing the theoretically maximum achievable throughput for 802.11b networks as a function of the payload size. Note that the throughput plotted in the graph is the net-throughput which is to be shared between all nodes in a BSS.

As FIG. 2 shows, the effective throughput has a large dependency on the payload size. The graph shows the theoretical limits vis-à-vis the packet size for 802.11b WLANs. The throughput in Megabits per second are graphed against Bytes per Packet Size Data Unit. Graphline 28 shows theoretical limits for 22 Mbps, line 30 shows theoretical limits for 11 Mbps, and line 32 shows theoretical limits for 5.5 Mbps. Again, even though this is not an issue for data applications (since they large payload sizes), the payload and packet sizes can significantly affect voice data transmissions for real time applications like VoIP where the packet size needs to be kept short to minimized end-to-end delay. To summarize, since 802.11b has high overheads and since voice packets need to be small, VoIP has very limited throughput available for operation.

Tests have shown that the number of VoIP calls that can exist in a BSS is a factor of the packetization period used to transmit the voice data. For example, the maximum number of simultaneous VoIP connections in a single BSS using a G.711 a-Law codec is 6 for 10 msec packets, 12 for 20 msec packets, and 17 for 30 msec packets. In sum, the number of VoIP connections that can exist in a BSS increases with the use of larger packetization periods. However, higher payload sizes mean larger end-to-end delays in VoIP. Thus, there is an engineering trade-off between the end-to-end delay and WLAN system capacity.

There is another aspect of the 802.11b which further restricts the available bandwidth for VoIP calls. This is the inherent fairness of the 802.11b protocol which does not discriminate between priority of nodes (e.g., endpoints) as far as access to the medium is concerned. This method is adequate when used for data traffic where the upstream traffic is much less than downstream traffic and the AP rarely has to compete with other nodes to access the wireless medium. However, for VoIP where traffic is bi-directionally balanced, each node is transmitting as much traffic as it is receiving (assuming no asymmetric codecs), and the voice data traffic has to traverse through the AP. This means that if there are N wireless IP phones (WIPPs) in a BSS making calls to wired networks, the AP is handling N times the load as compared to any other node in the BSS. However, fairness in 802.11b would allow the AP to access the medium only as much as any other node. The result is that the AP will not be able to transmit the traffic that it is receiving. Since voice calls over a WLAN require real time traffic, a voice data packet which gets delayed beyond a limit waiting in the AP queue is rendered useless.

Thus, four of the major reasons for limited VoIP call capacity in a BSS are 1) large header transmission overhead, 2) ACK for each packet, 3) fixed values of Contention Window and DIFS for each station and frame, and 4) equal access priority for all stations in a BSS.

### SUMMARY

The present invention includes a method for transmitting a call using a wireless IP phone over a WLAN using a decision process for the admission of the call and selecting call parameters based upon the priority level of the call and congestion level of the network. The present invention optimizes the tradeoffs between call quality and the number of calls on a BSS. Once priority levels have been determined for calls in a WLAN, the network congestion level is monitored.

As the level of congestion in the network increases, only calls above a certain priority level are allowed into the network. This is an admission control policy wherein the higher the call priority, the higher the probability that the WIPP is able to place or receive a call. Higher priority also results in higher call quality (e.g., lower end-to-end delays) as network conditions permit. The admission control policy may also reserve a certain spectrum of bandwidth within the network for emergency calls.

### BRIEF DESCRIPTION OF THE DRAWINGS

Preferred embodiments of the invention are discussed hereinafter in reference to the drawings, in which:

FIG. 1 illustrates an enterprise wireless local area network;

FIG. 2 illustrates a graph showing throughput versus bytes per data unit in an IEEE 802.11b wireless local area network;

FIG. 3 illustrates an enterprise wireless local area network with a wireless IP phone associates to an access point;

FIG. 4 illustrates a flowchart of the preferred embodiment for call parameter selection and self-enforced admission.

### DETAILED DESCRIPTION OF PREFERRED EMBODIMENTS

The preferred embodiment of the present invention includes a technique to optimize voice over Internet Protocol (VoIP) performance in a wireless local area network (WLAN) by basing a decision of admission control and the value of end-to-end delay for a call that the BSS (Basic Service Set) can support on the congestion level in a BSS and priority level of the call. One implementation of the preferred embodiment is on an IEEE 802.11 wireless local area network (WLAN).

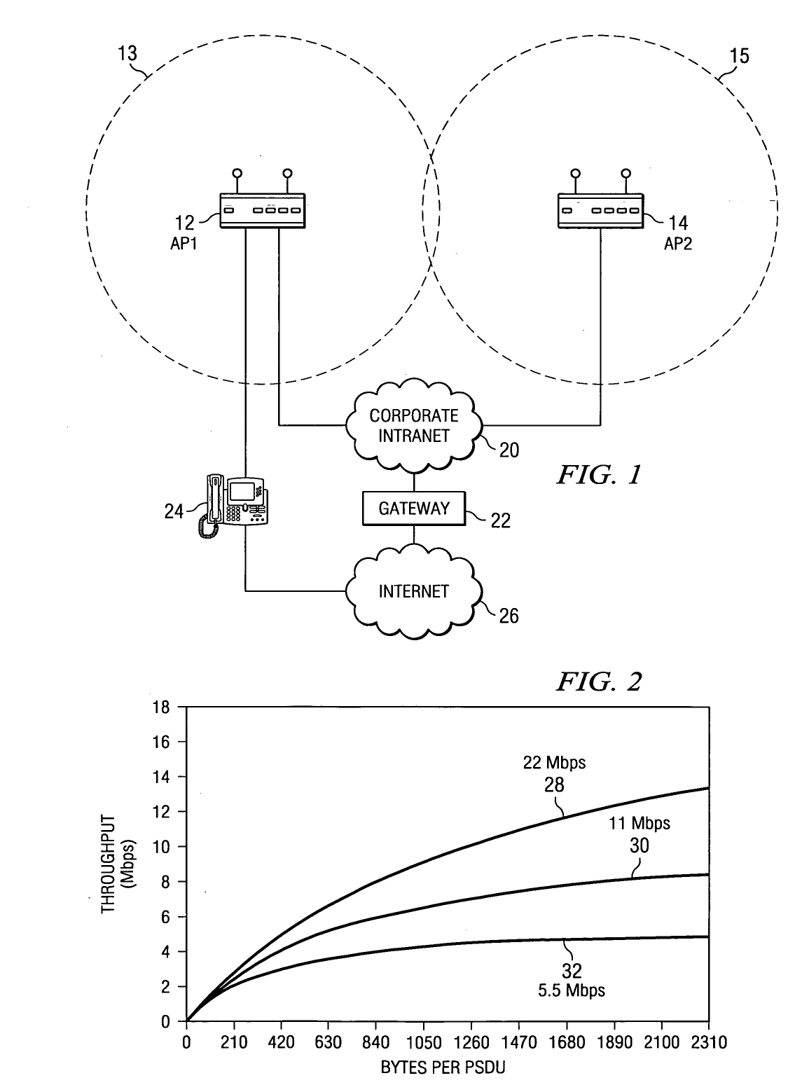

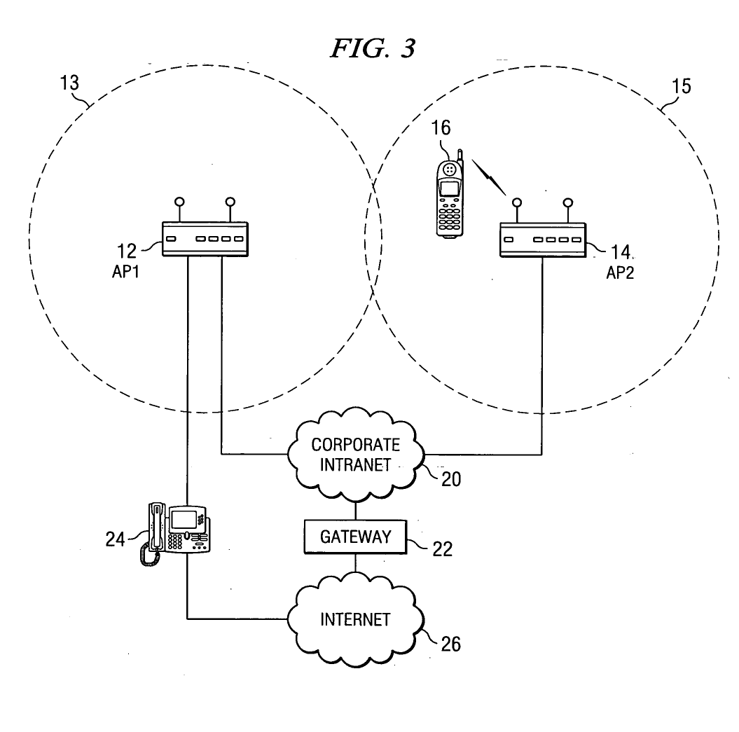

FIG. 3 illustrates a diagram of the enterprise WLAN network of FIG. 1 that with a WIPP (Wireless Internet Protocol Phone, or IP Phone) 16 associated with an access point (AP) 14. The exemplary network may be an IEEE 802.11 wireless local area network that is typically is employed by a commercial office, industrial complex, or academic facility and includes corporate intranet 20 that routes VoIP calls through Internet 26. For implementing voice capability, a wireless LAN may use multiple access points and multiple access technologies (e.g., 802.11 a/g) to minimize interference and increase capacity and coverage. A WLAN may also be used to place voice calls using a WIPP that transmits data signals using voice protocols, such as voice over Internet Protocol (VoIP). WIPP 16 can “roam” between APs 12 and 14 allowing a user of the phone to move within the signal coverage areas 13 and 15 without dropping a call. While “roaming” is defined as the ability for a cellular phone customer to automatically make and receive calls when the cellular handset has geographically moved outside of a service provider's home network coverage area and use an alternate network operated by a different service provider, “roaming” between APs refers to a same concept to move mobile phone 36 between different APs on the same ESS.

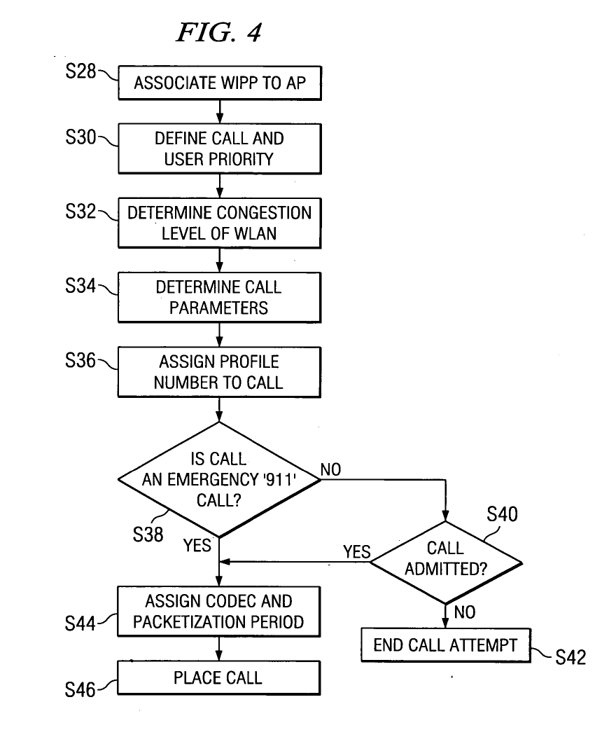

Referring contemporaneously to FIG. 4, AP2 broadcasts a connection profile along with association signals. When the profile signal is detected, the WIPP 16 transmits an association request to the transmitting AP2, and AP2responds back with an association response. Once the response is received, the WIPP 16 may enter an authentication process S28 with the authentication server 24 or receive authentication through a service provider on Internet 26.

After association, a VoIP call may be established by WIPP 16 on the BSS. The WIPP 16 then enters a decision process to determine the admission control of the call according to the method of the preferred embodiment. The admission control and the value for end-to-end delay of a call is based upon the network congestion level and a priority of the call. The term “priority” is used in a generic sense and the “priority” of a call can be defined differently for different implementations.

An exemplary priority of a call can be determined under two different definitions. Each user STA, is assigned a “user level priority,” with which all calls originating from and/or terminating at a particular STA is assigned the user's priority level. This is an example of statistically assigned priority levels that are based on the assumption that some users are more important than others. For example, a vice-president of a company may be assigned a higher priority level than the priority level of a staff-level engineer at the company.

Another type of priority for a call is a “destination number priority.” This type of priority of a call is assigned during call set up time depending on the destination number. The destination number priority is a dynamically assigned priority and is based on the assumption that all calls are not equally important. For example, calls placed for emergency response, such as calls to “911” have the highest priority and calls designated as “official” calls are more important than calls designated as “personal” calls.

Preferably, a combination of static and dynamic priority levels are set wherein each WIPP is assigned a base priority. The priority of calls originating from the WIPP may be dynamically incremented or decremented from the base priority. The incrementation or decrementation is based on the destination number or any other type of application or policy criterion.

The decision of admission control for a WIPP call is based on the congestion level of the WLAN and the priority of the call. Admission control for a call is “self-enforced,” meaning the STAs which use the present method are interoperable with any AP and do not require additional features added to an AP for compatibility. The self-enforcing admission control operates under two assumptions. First, it is assumed that the AP being used for VoIP is dedicated hardware for serving only VoIP users. If the AP is not dedicated hardware, then VoIP traffic on the BSS would effectively be at a lower “priority” than other data traffic on the AP. A lowering of the priority of VoIP traffic occurs on a conventional AP because WIPPs would take steps to limit the network congestion by enforcing admission controls whereas data endpoints sharing the same BSS may or may not take steps for admission control. To implement a dedicated VoIP AP, a BSS could co-locate two APs, each with adequate frequency and channel-number separation, in the same geographical area and dedicate one AP to data applications and the second AP to VoIP applications.

The second assumption calls for all WIPPs in a BSS to follow the preferred admission control policy. This is required because the method of the preferred embodiment relies on all WIPPs cooperating within the same BSS. If a single WIPP phone out of a group of WIPP phones in a BSS does not operate under the same admission controls, then the non-conforming WIPP could gain an effectual higher “priority” in terms of admission control into the BSS that it does not deserve. Since all WIPPs follow the admission policy, the policy can be implemented and enforced without interaction by the VoIP AP. Thus, the admission controls can be implemented without independent of any vendor-specific protocols or manufacturers of APs.

The first step to admission control is to assign a priority level to each WIPP in a BSS S30. As stated previously, each WIPP may have a User Level Priority and each call may have a Destination Number Priority. Once priority levels have been determined for calls in a WLAN, the next step is to monitor network congestion levels S32. As the level of congestion in the network increases, the admission control policy dictates that only calls above a certain priority level are allowed into the network. This is an admission control policy wherein the higher the call priority, the higher the probability that the WIPP is able to place or receive a call. Higher priority also results in higher call quality (e.g., lower end-to-end delays) as network conditions permit. The admission control policy may also reserve a certain spectrum of bandwidth within the network for emergency calls.

Next, standard call parameters are selected for each call S34. Parameters that affect VoIP over WLAN performance considered in the preferred embodiment are the codec, the packetization period, and voice activity detection (VAD). The selection of call parameters is based on the call priority and the current level of congestion in the BSS in which the WIPP is operating. A current level of congestion in a BSS can be determined by a number of methods known in the art, including the methodology proposed in the application END-POINT BASED APPROACH FOR DETERMINING NETWORK STATUS IN A WIRELESS LOCAL AREA NETWORK, filed contemporaneously and assigned to the same assignee as the present application.

Although not required, VAD should preferably be employed in VoIP over WLAN calls. Using VAD techniques known to those in the art can reduce the packets-per-second on the wireless media by approximately 50% and therefore reduce significantly the load on the network. However, using VAD could also increase congestion levels in a BSS and therefore should be carefully considered during implementation. The act of turning on VAD may have a conflicting effect with the 802.11b PowerSave mode since the WIPP may go into a Power Save mode when it detects that there is silence on both sides. If this does happen, the polling mode of WIPP may end up increasing the congestion in the network. A solution for this problem would be preventing the WIPP to go to sleep during a call. Obviously, the effect of this would be reduced talk time for the phone.

The selection of the packetization period and codec parameters should preferably be based on the congestion level and the priority of the call. Admission controls for calls is the BSS begin using increasing (e.g., higher) packetization periods for new calls. Further, lower priority calls are classified to use higher packetization periods for the selected coded before the packetization periods for higher priority calls are increased so that the higher priority calls suffer lower end-to-end delay as compared to lower priority calls.

The selection of codec is not a major factor when compared with the importance of packetization period selection as shown in On the Throughout of 802.11b Networks for VoIP, by Garg & Kappas. A single codec, such as ITU G.711, could be used for VoIP over WLAN calls while only varying the packetization period for the codec based on the congestion level of the BSS. However, most codec implementations work in memory and MIPS-constrained DSPs and do not support large packetizaion periods of some codecs, like G.711. Thus, the selection criterion of packetizaion period should preferably be used as a criterion for selecting the codec. For example, codec for G.711 is used for calls with increasing packetization periods and if, due to congestion even larger periods are required, then new calls are switched to a low bit rate codec such as ITU G.729.

The Admission Control Table shown below demonstrates the admission control and parameter selection method based on congestion level and priority. All of the VoIP over WLAN calls in the network are assigned a priority number between 1 and P, where 1 corresponds to the highest priority level and the variable P corresponds to a lowest priority level. The congestion level in the WLAN is calibrated between 1 and N, where 1 corresponds to a very lightly loaded (uncongested) WLAN and N corresponds to a highly loaded (congested) WLAN.

To determine call admission and parameters, the call and/or user is tagged with a Profile Number S36. Generally, the profile number of the call is the product of the congestion level calibration number (e.g., 1 to N) and the priority number (e.g., 1 to P). Special cases for assigning profile numbers are given special priority, including emergency calls as described below. The call priority is used an index to a parameter table. The parameter table consists of call parameters listed by codec in increasing order of packetizaion periods. Recall that admission controls place higher priority calls with lower packetizaion periods. Higher priority means that a user has access to make calls under admission control procedures and the quality of calls is higher. It is understood that admission controls are set by the network administrator and can vary depending on numerous factors including network capacity.

In the exemplary Admission Control Table, Pₘₐₓ=5(i.e. calls have priority between 1 and 5) and Nₘₐₓ=4(congestion status ranges between 1 and 4). This means that the full Table would have 20 entries instead of the seven entries shown. The PC_Status is the product of the Congestion Status and the Profile Number (PC_Status=Congestion Status * Profile Number). The Admission Control Table shown herein is an exemplary table that may be modified by each implementation as per its requirements. The Table can be made configurable so that the network engineer can set and modify the values for each deployed BSS.

ADMISSION CONTROL TABLE

| | Congestion | | Profile | |
|---|---|---|---|---|
| Priority | Status | PC_Status | Number | Codec |
| 1 | 1 | 1 | 1 | G.711 with 10 msec |
| | | | | pack. period |
| 2 | 1 | 2 | 2 | G.711 with 20 msec |
| | | | | pack. period |
| 3 | 1 | 3 | 3 | G.711 with 20 msec |
| | | | | pack. period |
| 1 | 2 | 2 | 2 | G.711 with 20 msec |
| | | | | pack. period |
| 2 | 2 | 4 | 4 | G.711 with 30 msec |
| | | | | pack. period |
| ● | | | | |
| ● | | | | |
| ● | | | | |
| 2 | 5 | 10 | 10 | No admission |
| 4 | 5 | 20 | 20 | No admission |

To determine if a call is admitted into the system according to admission controls S40, the priority and congestion level is analyzed. Generally, the higher the priority number, the higher the call quality and higher chances that the call will be able to be placed in the WLAN. Referring to the Table, the first row corresponds to a call given a highest priority number of 1 with the lowest Congestion Status level of 1, therefore the product of these two results, hereinafter referred to as the PC_Status, is a Profile Number of 1. This is the highest possible priority for call admission to the network and calls with this priority are assigned the smallest available packetization period of 10 msec with the G.711 codec S44. The smaller packetization period and lack of congestion on the network should result in a higher quality VoIP call placed by the user S46.

The second row of the Admission Control Table corresponds to a call with Priority of 2 and Congestion Level 1. The Priority Number for this call is 2 and would be given a codec of G.711 with 20 msec packetization period. The Admission Control Table continues for each call made in the WLAN. The last two rows show calls with Profile Numbers of 10 and 20, respectively. Because of the calls' low priority status and high network congestion levels, both calls are not allowed to be placed on the network.

Although not a requirement, the admission control and parameter selection of the preferred embodiment assumes that the VoIP calls are symmetric, i.e. the call parameters used in upstream and downstream directions of the call are identical. This assumption is typically true regarding VoIP implementations in WLANs and wired networks. Further, if an incoming call offers a list of options for call parameters that the WIPP phone may use for a call, the preferred embodiment may be used to select appropriate call parameters in addition to the standard admission control.

The admission control and parameter select methods may be modified so that access is always provided for certain calls. To reserve bandwidth for emergency calls S38, first, for the highest congestion-level in the network, set the PC_Status as (Nₘₐₓ* Pₘₐₓ+1). Second, use a priority of zero for all emergency calls. For example, a BSS has Pₘₐₓ=5(i.e.,here, calls have priority between 1 and 5) and Nₘₐₓ=4(congestion status ranges between 1 and 4). The range of values is set such that PC_Status can take to be {1,2,3,21} i.e.
when congestion status is 1, set PC_Status=1
when congestion status is 2, set PC_Status=2
when congestion status is 3, set PC_Status=3
when congestion status is 4, set PC_Status=21(4*5+1)
   When the congestion status reaches 4, no non-emergency calls would be allowed since even for a call with priority=1, the PC_Status calculated would be too high. This means that once the congestion level in the network reaches 4, only emergency calls S38 (with priority 0) would be allowed in the network S46. In effect, bandwidth has been reserved above congestion level 4 for emergency calls. To reserve more even bandwidth for emergency calls, set PC_Status=21 when congestion status reaches 3. This would reserve the bandwidth above congestion level 3 for emergency calls.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

What is claimed:

1. A method for admission control of voice calls in a wireless local area network, comprising:
associating a plurality of wireless endpoint stations with an access point in a wireless local area network (WLAN);
assigning a priority to each voice call from said wireless stations;
determining a congestion level of said WLAN;
determining if each of said voice calls from said wireless station are admitted to be placed through said WLAN based on said priority and said congestion level; and
if one of said voice calls is admitted, assigning a call parameter to said admitted voice call.

2. The method of claim 1, wherein said associated comprises associates a plurality of wireless Internet Protocol phones to said access point.

3. The method of claim 1, wherein said assigning a priority comprises assigning a destination number priority to each said voice call.

4. The method of claim 1, wherein said assigning a priority comprises assigning user level priority to each said voice call.

5. The method of claim 1, wherein said assigning the call parameter comprises selecting a codec and a packetization period for said admitted voice call, wherein said selection is based on said priority of said admitted voice call and said congestion level.

6. The method of claim 1, wherein said assigning a priority further comprises:
assigning a profile number to said voice call, wherein said profile is a product of numbers representing the priority and the congestion level of the WLAN.

7. The method of claim 6, further comprising:
determining if said voice call from said wireless station is admitted into said WLAN based on said profile number.

8. The method of claim 1, further comprising:
reserving bandwidth in said WLAN for an emergency call; and
assigning a highest priority to said emergency call placed by said wireless station.

9. A method for admission control of voice calls in a wireless local area network, comprising:
associating a plurality of wireless stations with an access point in an Institute of Electronic and Electrical Engineers (IEEE)802.11 wireless local area network (WLAN);
assigning one of a destination number priority and a user level priority to each voice call attempted to be placed on said WLAN from said wireless stations;
determining a congestion level of said WLAN;
calculating a profile number as the product of said congestion level and one of said destination number priority and said user level priority.

10. The method of claim 9, further comprising:
performing admission control into said WLAN of each said attempted voice calls by admitting said attempted voice calls through said WLAN that exceed a profile number threshold.

11. The method of claim 9, further comprising:
selecting a codec and a packetization period for each said admitted voice call, wherein said selection is based on said priority of said admitted voice call.

12. The method of claim 9, further comprising:
selecting a codec and a packetization period for each said admitted voice call, wherein said selection is based on said congestion level.

13. The method of claim 9, further comprising:
reserving bandwidth in said WLAN for an emergency call; and
assigning a highest destination number priority to said emergency call.
